(19) United States
(12) Patent Application Publication
(10) Pub. No.: US 2019/0086730 A1
(43) Pub. Date: Mar. 21, 2019

(54) DRIVING APPARATUS OF DISPLAY DEVICE AND DRIVING METHOD THEREOF

(71) Applicant: HKC Corporation Limited, Shenzhen City, Guangdong (CN)

(72) Inventor: Beizhou HUANG, Shenzhen City, Guangdong (CN)

(21) Appl. No.: 15/738,738

(22) PCT Filed: Oct. 20, 2017
(86) PCT No.: PCT/CN2017/107021

§ 371 Date: Dec. 21, 2017

(30) Foreign Application Priority Data
Sep. 19, 2017 (CN) 201710847370.2

(51) Int. Cl. G02F 1/1335; G02F 1/133; G09G 3/36

(52) U.S. Cl. CPC G02F 1/133611; G02F 1/13306; G02F 2201/121; G09G 2320/0233; G09G 2320/0276; G09G 3/3648

(57) ABSTRACT

A driving apparatus comprises: a first substrate including: a storage unit electrically connected to a display module, the storage unit saving display parameters of the display module, wherein the display parameters include a gamma correction code, a common electrode voltage setting code, and an uneven brightness distribution compensation module code; and a second substrate including: a control module electrically coupled to the storage unit, for reading the display parameters saved in the storage unit and adjusting driving parameters for the display module, wherein the display module electrically is coupled to the first substrate through a serial peripheral interface, and an integrated circuit bus electrically is coupled to a timing control unit and a programmable gamma correction buffer circuit unit.

### BACKGROUND OF THE INVENTION

### Field of Invention

The present invention generally relates to a method of improving driving apparatus efficiency for a display device, especially a driving apparatus of a display device and a driving method thereof.

### Description of Related Art

In recent years, a liquid crystal display (LCD) is widely used in a variety of technical fields. With an improving of driving technology, the liquid crystal display (LCD) has many advantages, such as low electric consumption, thin and light, low driving voltage, etc. Currently, the liquid crystal display (LCD) has been widely used in video recorders, notebook computers, desktop monitors and a variety of projection equipment.

A liquid crystal display (LCD) usually includes a gate driving circuit, a source driving circuit, and a pixel array. There are a plurality of pixel circuits in the pixel array, wherein each pixel circuit turns on and off according to a scan signal provided by the gate driving circuit, and shows a data image according to a data signal provided by the source driving circuit.

Currently, a large size liquid crystal display (LCD) is a structure of a separation circuit board (X board, XB) and a control board (CB), and software codes of a main unit are saved in different memories which are all set on the control board. However, the foregoing software codes all set on the control board will generate some problems. For example, because of the manufacturing process, each panel will be slightly different. Each panel accordingly needs to have independent gamma correction, common electrode voltage setting, and so on, so that each panel can achieve the best display quality. Therefore, components therein need to be open one-on-one corresponding to the control board. However, it makes a big problem for packaging, transportation and component assembly.

### SUMMARY OF THE INVENTION

In view of resolving the above technical issues, the present invention is to provide a driving apparatus of a display device and a driving method thereof. The present invention can be applied to a display product with separation circuit board and control board. The present invention can overcome a problem of differences between display panels, improve display product quality, and reduce additional cost and difficulty in packaging, assembly and operation.

The objects and technical solutions of the present invention are implemented by following technical ways and means. In one perspective, the present invention provides a driving apparatus of a display device, comprising: a first substrate including: a storage unit electrically connected to a display module, for saving display parameters of the display module, wherein the display parameters include a gamma correction code, a common electrode voltage setting code, and an uneven brightness distribution compensation module code; and a second substrate including: a control module electrically coupled to the storage unit, for reading the display parameters saved in the storage unit and adjusting driving parameters for the display module, wherein the display module electrically is coupled to the first substrate through a serial peripheral interface, and an integrated circuit bus is electrically coupled to a timing control unit and a programmable gamma correction buffer circuit unit separately.

In another perspective, the present invention provides a driving method of a display device comprising: setting a storage unit through a first substrate, wherein the storage unit saves display parameters including a gamma correction code, a common electrode voltage setting code and an uneven brightness distribution compensation module code; electrically coupled to the storage unit through a control module in the second substrate, for reading the display parameters saved in the storage unit and adjusting driving parameters of a display module, and setting a timing control unit and a programmable gamma correction buffer circuit unit, wherein an uneven brightness distribution compensation module is embedded in the timing control unit, and a gamma correction module and a common electrode voltage setting module are embedded in the programmable gamma correction buffer circuit unit; providing a serial peripheral interface, the serial peripheral interface electrically coupled to the timing control unit and the storage unit separately; and providing an integrated circuit bus, the integrated circuit bus electrically coupled to the timing control unit and the programmable gamma correction buffer circuit unit separately.

In another perspective, the present invention provides a driving apparatus of a display device, comprising: a first substrate including: a storage unit electrically connected to a display module, for saving display parameters of the display module; a second substrate including: a control module electrically coupled to the storage unit, for reading the display parameters saved in the storage unit and adjusting driving parameters for the display module; a timing control unit for controlling a display sequence of a pixel and transmitting a signal to a driving unit of the display module; a programmable gamma correction buffer circuit unit dynamically monitoring and adjusting a voltage by a software; a serial peripheral interface electrically coupled to the timing control unit and the storage unit separately; an integrated circuit bus electrically coupled to the timing control unit and the programmable gamma correction buffer circuit unit separately; and a power control unit for providing a power to the timing control unit. The present storage unit further comprises a gamma correction code, a common electrode voltage setting code and an uneven brightness distribution compensation module code. The common electrode voltage setting code is electrically coupled to the gamma correction code and the uneven brightness distribution compensation module e code separately. The timing control unit further comprises an uneven brightness distribution compensation module. The programmable gamma correction buffer circuit unit further comprises a gamma correction module and a common electrode voltage setting module. The gamma correction module is electrically coupled to the common electrode voltage setting module.

The objects and technical solutions of the present invention can be further implemented by following technical configuration and means.

In one embodiment of the present invention, the storage unit further comprises a gamma correction code, a common electrode voltage setting code, and an uneven brightness distribution compensation module code. The common electrode voltage setting code is electrically coupled to the gamma correction code and the uneven brightness distribution compensation module code separately.

In one embodiment of the present invention, the present invention further comprises: a timing control unit for controlling a display sequence of a pixel and transmitting a signal to a driving unit of the display module; a programmable gamma correction buffer circuit unit dynamically monitoring and adjusting a voltage by a software; a serial peripheral interface electrically coupled to the timing control unit and the storage unit separately; and an integrated circuit bus electrically coupled to the timing control unit and the programmable gamma correction buffer circuit unit separately.

In one embodiment of the present invention, the timing control unit further comprises an uneven brightness distribution compensation module.

In one embodiment of the present invention, the programmable gamma correction buffer circuit unit further comprises a gamma correction module and a common electrode voltage setting module.

In one embodiment of the present invention, the gamma correction module is electrically coupled to the common electrode voltage setting module.

In one embodiment of the present invention, in the present driving method, the step of providing the serial peripheral interface and electrically coupled to the serial peripheral interface to the timing control unit and the storage unit separately, comprises: when the power is on, the timing control unit passing through the serial peripheral interface; reading the uneven brightness distribution compensation module code saved in the storage unit according to storage addresses; and transmitting to the uneven brightness distribution compensation module for data matching.

In one embodiment of the present invention, in the present driving method, the step of providing an integrated circuit bus, the integrated circuit bus electrically coupled to the timing control unit and the programmable gamma correction buffer circuit unit separately, comprises: reading the gamma correction code and the common electrode voltage setting code in the storage unit; passing through the integrated circuit bus; and transmitting to the gamma correction module and the common electrode voltage setting module in the programmable gamma correction buffer circuit unit for data matching.

### BRIEF DESCRIPTION OF THE DRAWINGS

FIG. 1 illustrates an exemplary display pixel array in a liquid crystal display (LCD) panel.

FIG. 2 illustrates an exemplary equivalent capacitance load of related display pixel and related switch components in a liquid crystal display (LCD) panel.

FIG. 3 illustrates another exemplary equivalent capacitance load of related display pixel and related switch components in a liquid crystal display (LCD) panel.

FIG. 4 illustrates a display device according to one embodiment of the present invention.

FIG. 5 illustrates a communication architecture according to one embodiment of the present invention.

### DESCRIPTION OF THE PREFERRED EMBODIMENTS

The drawings as referred to throughout the description of the present invention are examples for implementing the objects of the present invention. The orientation words or terms used in the description of the present invention, such as “above”, “under”, “forward”, “backward”, “left”, “right”, “inner”, “outer”, “side”, etc. are examples in the drawings for illustrative purpose only, or just show the interrelations between the components, but not to be construed as limitations to the scope of the present invention.

The drawings and the description of the present invention are deemed to be examples but not limitations essentially. In the drawings, components or elements having similar or same structure are marked with the same numbers. In addition, sizes and thicknesses of every component or element are just examples, but not drawn according to actual scale and not read as limitations to the scope of the present invention.

In drawings of the present invention, sizes and thicknesses of layers, films, panels, or regions are emphasized for clearness, easy to describe and easy to understand. Therefore, some layers, films, or regions are emphasized but not drawn according to their actual scales. It is to be understood that, for example, when one of the components of layers, films, regions, or substrate are “on” another component of layers, films, regions, or substrate, the one of the components of layers, films, regions, or substrate could be adjacent on another component of layers, films, regions, or substrate directly, or there could be other inter-components of layers, films, regions, or substrate set therebetween.

Furthermore, in the description of the present invention, a word “comprising” or “including” is construed to comprise or include the related components but not exclude other components, except there is clearly opposite word or description in the present invention. And, in the description of the present invention, a word “on” is construed to be above or under a target component, but not construed to be limited on a top of the target component in vertical or gravity direction.

For further clarifying the technical solutions or functions of the present invention to implement the objects of the present invention, a driving apparatus and a driving method for a display device, and their specific implementations, structures, features, and functions, according to a preferred embodiment of the present invention will be apparent from the following detailed description, which proceeds with reference to the accompanying drawings.

The present liquid crystal display (LCD) panel can include an active switch array (thin film transistor, TFT) substrate plate, a color filter (CF) layer substrate plate, and a liquid crystal (LC) layer, an organic light-emitting diode (OLED) display panel or a quantum dots light-emitting diode (QLED) display panel which is formed between the two substrate plates above-mentioned.

In one embodiment of the present invention, the liquid crystal display (LCD) panel could be a curved type display panel.

In one embodiment of the present invention, the active array (thin film transistor, TFT) and the color filter (CF) substrate of the present invention can be formed on the same substrate.

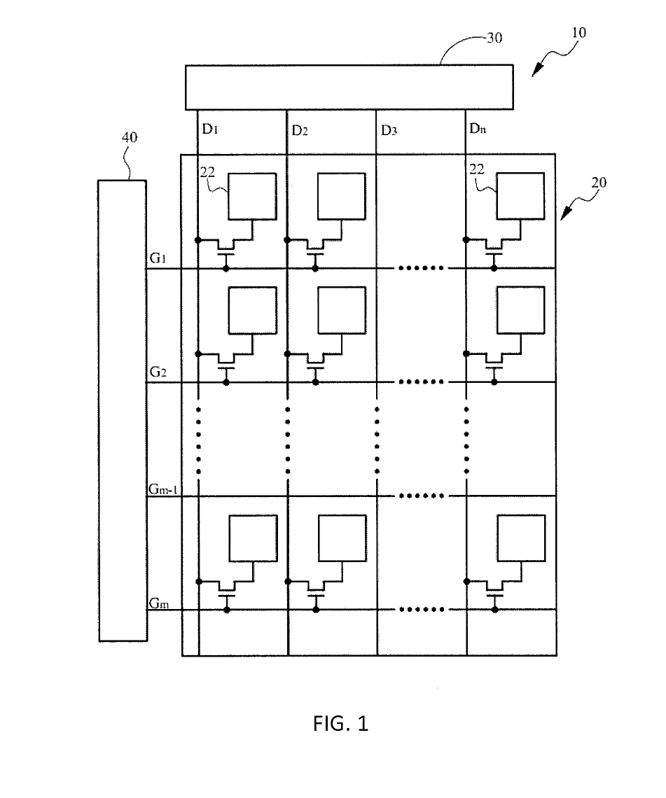

FIG. 1 illustrates an exemplary display pixel array in a liquid crystal display (LCD) panel. Please refer to FIG. 1, a liquid crystal display (LCD) panel 10 includes a display module 20 composed of a plurality of pixels 22 arranged in a two-dimensional array. The pixels 22 are controlled and driven by a plurality of data lines D1, D2, . . . , Dn and a plurality of gate lines G1, G2, . . . , Gm. A data line signal of each data line is provided by a data driving unit 30, and a gate line signal of each gate line is provided by a gate driving unit 40.

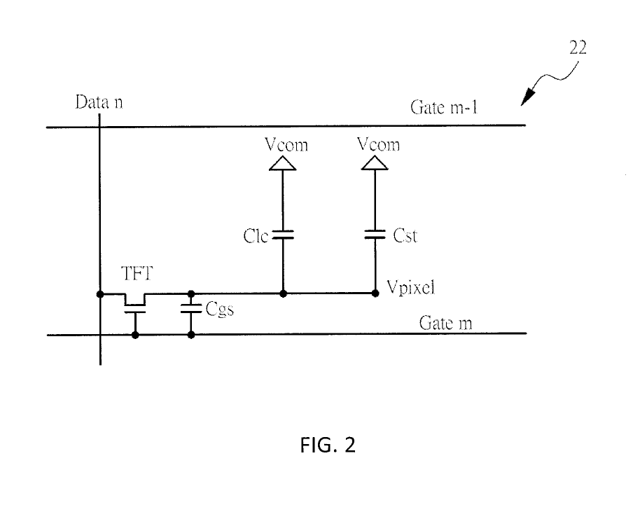

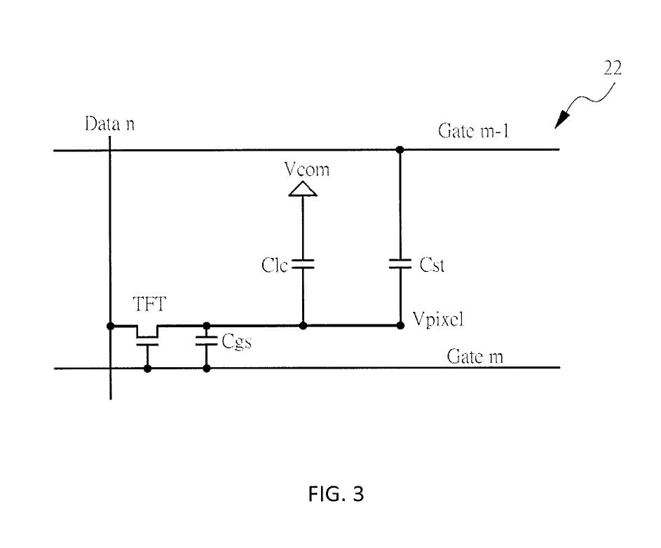

FIG. 2 illustrates an exemplary equivalent capacitance load of related display pixel and related switch components in a liquid crystal display (LCD) panel. FIG. 3 illustrates another exemplary equivalent capacitance load of related display pixel and related switch components in a liquid crystal display (LCD) panel. Please refer to FIGS. 2 and 3, each pixel 22 includes and is coupled to a plurality of capacitors. For example, the pixel 22 includes and is coupled to a capacitor Clc formed by a liquid crystal layer between a top electrode and a bottom electrode, an additional charge storage capacitor Cst for maintaining a voltage at a Vpixel value after a gate line signal passes through, and a capacitor Cgs coupled to a gate end and a source end of the switch components (an active switch, for example TFT). It is noted that a pixel total capacitance of a liquid crystal display (LCD) panel may change or vary due to the size of the pixel, the thickness of the liquid crystal layer, the size of the storage capacitor, and several other techniques that are known by those skilled in the art. As shown in FIG. 2, both the capacitors Clc and Cgs are connected to a common voltage Vcom. As shown in FIG. 3, the capacitor Cst is connected with a gate line.

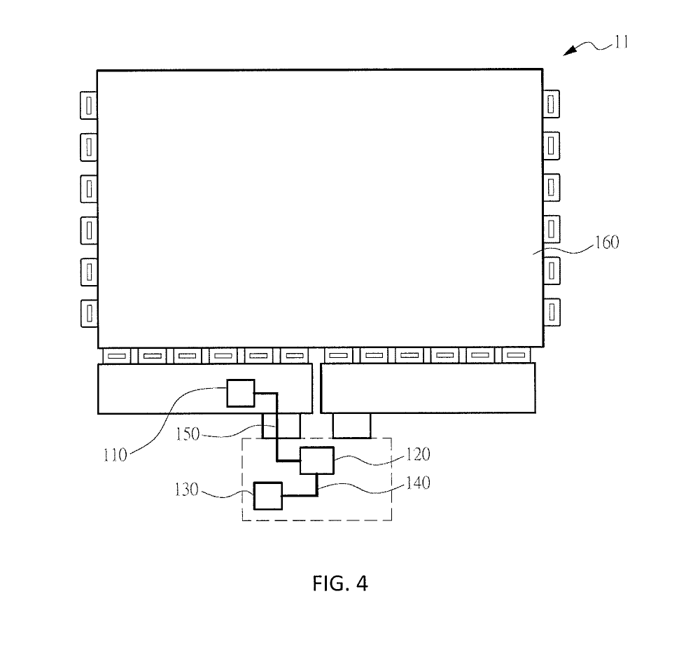

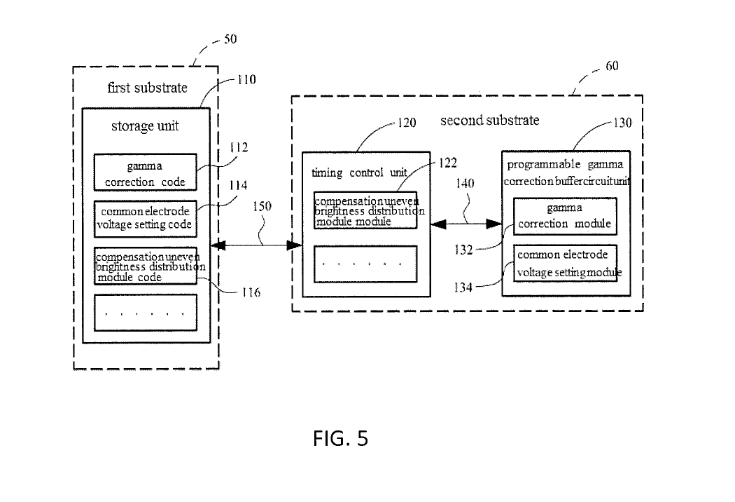

FIG. 4 illustrates a display device according to one embodiment of the present invention. FIG. 5 illustrates a communication architecture according to one embodiment of the present invention. Please refer to FIGS. 4 and 5, in one embodiment of the present invention, a driving apparatus 11 of a display device comprises: a display module 160; a first substrate 50 including: a storage unit 110 electrically connected to the display module 160, the storage unit 110 saving display parameters of the display module 160, wherein the display parameters include a gamma correction code 112, a common electrode voltage setting code 114, and an uneven brightness distribution compensation module code 116; a second substrate 60 including: a control module (not shown) electrically coupled to the storage unit 110, the control module for reading the display parameters saved in the storage unit 110 and adjusting driving parameters for the display module 160; wherein the display module 160 is electrically coupled to the first substrate 50 through a serial peripheral interface 150; and an integrated circuit bus 140 electrically is coupled to timing control unit 120 and a programmable gamma correction buffer circuit unit 130 separately. The present driving apparatus 11 further comprises: the timing control unit 120 for controlling a display sequence of the pixel and transmitting the foregoing signal (the gate line signal or the data line signal) to the foregoing driving unit (the gate driving unit or the data driving unit) of the display module 160; a programmable gamma correction buffer circuit unit 130 using a software to dynamically monitor and adjust a voltage; a serial peripheral interface 150 electrically coupled to the timing control unit 120 and the storage unit 110 separately; an integrated circuit bus 140 electrically coupled to the timing control unit 120 and the programmable gamma correction buffer circuit unit 130 separately.

In one embodiment of the present invention, the storage unit 110 further comprises: a gamma correction code 112, a common electrode voltage setting code 114, and an uneven brightness distribution compensation module code 116.

In one embodiment of the present invention, the common electrode voltage setting code 114 is electrically coupled to the gamma correction code 112 and the uneven brightness distribution compensation module code 116.

In one embodiment of the present invention, the timing control unit 120 further comprises: an uneven brightness distribution compensation module 122.

In one embodiment of the present invention, the programmable gamma correction buffer circuit unit 130 further comprises: a gamma correction module 132 and a common electrode voltage setting module 134 common electrode voltage setting module 134.

Please refer to FIGS. 4 and 5, in one embodiment of the present invention, a driving apparatus 11 of a display device comprises: a display module 160; a first substrate 50 including: a storage unit 110 electrically connected to the display module 160, the storage unit 110 saving display parameters of the display module 160; a second substrate 60 including: a control module (not shown) electrically coupled to the storage unit 110, the control module for reading the display parameters saved in the storage unit 110 and adjusting driving parameters for the display module 160; a timing control unit 120 for controlling a display sequence of the pixel and transmitting a signal to a driving unit of the display module 160; a the programmable gamma correction buffer circuit unit 130 dynamically monitoring and adjusting a voltage by a software; a serial peripheral interface 150 electrically coupled to the timing control unit 120 and the storage unit 110 separately; an integrated circuit bus 140 electrically coupled to the timing control unit 120 and the programmable gamma correction buffer circuit unit 130 separately; and a power control unit (not shown) for providing a power to the timing control unit 120; wherein the storage unit 110 further comprises: a gamma correction code 112, a common electrode voltage setting code 114, and an uneven brightness distribution compensation module code 116; the common electrode voltage setting code 114 electrically coupled to the gamma correction code 112 and the uneven brightness distribution compensation module code 116 separately; the timing control unit 120 further comprising an uneven brightness distribution compensation module 122; the programmable gamma correction buffer circuit unit 130 further comprising a gamma correction module 132 and a common electrode voltage setting module 134; and the gamma correction module 132 electrically coupled to the common electrode voltage setting module 134.

Please refer to FIG. 5, in one embodiment of the present invention, in a production line, a present driving method for a display device is provided. At first, a common electrode voltage is adjusted to an optimal voltage value for each display panel. The above-mentioned common electrode voltage setting code 114 is saved in the storage unit 110. And, processes of gamma correction and mura compensation are performed to form a gamma correction code 112 and an uneven brightness distribution compensation module code 116. Then, the gamma correction code 112 and the uneven brightness distribution compensation module code 116 are saved in the storage unit 110, wherein different codes are saved in different addresses so that the timing control unit 120 can read them correctly. Therefore, each panel can have their own matching information (codes or parameters), so that it is unnecessary to provide an extra control board for each panel.

Please continue to refer to FIGS. 4 and 5, in one embodiment of the present invention, a present driving method for a display device comprises: providing a first substrate 50; setting a storage unit 110 on the first substrate 50, wherein the storage unit 110 saves a gamma correction code 112, a common electrode voltage setting code 114 and an uneven brightness distribution compensation module code 116; providing a second substrate 60; electrically coupled to the storage unit 110 to a control module (not shown) of the second substrate 60; for reading display parameters saved in the storage unit 110 and adjusting driving parameters for the display module 160; setting a timing control unit 120 and a programmable gamma correction buffer circuit unit 130, wherein an uneven brightness distribution compensation module 122 is embedded in the timing control unit 120, and a gamma correction module 132 and a common electrode voltage setting module 134 are embedded in the programmable gamma correction buffer circuit unit 130; providing a serial peripheral interface 150; electrically coupled to the serial peripheral interface 150 to the timing control unit 120 and the storage unit 110 separately; and providing an integrated circuit bus 140; electrically coupled to the integrated circuit bus 140 to the timing control unit 120 and the programmable gamma correction buffer circuit unit 130 separately.

In one embodiment of the present invention, in the present driving method, the step of providing the serial peripheral interface 150 electrically coupled to the timing control unit 120 and the storage unit 110 comprises: when the power is on, the timing control unit 120 reading the uneven brightness distribution compensation module code 116 according to storage addresses through the serial peripheral interface 150. Then a signal is transmitted to the uneven brightness distribution compensation module 122 for data matching.

In one embodiment of the present invention, in the present driving method, the step of providing the integrated circuit bus 140 electrically coupled to the timing control unit 120 and the programmable gamma correction buffer circuit unit 130 comprises: reading the gamma correction code 112 and the common electrode voltage setting code 114 in the storage unit 110; then a signal is transmitted to the gamma correction module 132 and the common electrode voltage setting module 134 in the programmable gamma correction buffer circuit unit 130 through the integrated circuit bus 140 for data matching.

In one embodiment of the present invention, the display panel could be, but not limited to, a twisted nematic (TN) display panel, an optically compensated birefringence (OCB) display panel, or a vertical alignment (VA) display panel. The display panel of the display device could also be a curved liquid crystal display (LCD) panel. In addition, a display panel could further be, for example, an organic light-emitting diode (OLED) display panel, a quantum dots light-emitting diode (QLED) display panel, a curved display panel or other display panel.

The present invention can be applied to a display product with separation circuit board and control board. The present invention can overcome a problem of differences between display panels, improve display product quality, and reduce additional cost and difficulty in packaging, assembly and operation.

“In some embodiments of the present invention” and “In a variety of embodiments of the present invention” are used repeatedly through the description. They usually mean different embodiments. However, they can also mean the same embodiments. “Comprising”, “having” and “including” are synonyms, except it is noted to be different or has other meanings before and after its description.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. It is not limited to each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment

What is claimed is:

1. A driving apparatus of a display device, comprising:
a first substrate including:
a storage unit electrically connected to a display module, for saving display parameters of the display module, wherein the display parameters include a gamma correction code, a common electrode voltage setting code, and an uneven brightness distribution compensation module code; and
a second substrate including:
a control module electrically coupled to the storage unit, for reading the display parameters saved in the storage unit and adjusting driving parameters for the display module, wherein the display module is electrically coupled to the first substrate through a serial peripheral interface, and an integrated circuit bus electrically is coupled to a timing control unit and a programmable gamma correction buffer circuit unit.

2. The driving apparatus of a display device according to claim 1, wherein the storage unit further include a gamma correction code, a common electrode voltage setting code, and an uneven brightness distribution compensation module code.

3. The driving apparatus of a display device according to claim 2, wherein the common electrode voltage setting code is electrically coupled to the gamma correction code and the uneven brightness distribution compensation module code.

4. The driving apparatus of a display device according to claim 1, further comprising: a timing control unit for controlling a display sequence of a pixel and transmitting a signal to a driving unit of the display module.

5. The driving apparatus of a display device according to claim 4, further comprising: the programmable gamma correction buffer circuit unit dynamically monitoring and adjusting a voltage by a software.

6. The driving apparatus of a display device according to claim 4, further comprising: a serial peripheral interface electrically coupled to the timing control unit and the storage unit.

7. The driving apparatus of a display device according to claim 5, further comprising: an integrated circuit bus electrically coupled to the timing control unit and the programmable gamma correction buffer circuit unit.

8. The driving apparatus of a display device according to claim 1, wherein the timing control unit further comprises: an uneven brightness distribution compensation module.

9. The driving apparatus of a display device according to claim 1, wherein the programmable gamma correction buffer circuit unit further comprises: a gamma correction module.

10. The driving apparatus of a display device according to claim 9, wherein the programmable gamma correction buffer circuit unit further comprises: a common electrode voltage setting module.

11. The driving apparatus of a display device according to claim 10, wherein the gamma correction module is electrically coupled to the common electrode voltage setting module.

12. A driving method of a display device comprising:
setting a storage unit through a first substrate, wherein the storage unit saves display parameters including a gamma correction code, a common electrode voltage setting code and an uneven brightness distribution compensation module code;
electrically coupled to the storage unit through a control module in the second substrate, for reading the display parameters saved in the storage unit and adjusting driving parameters of a display module, setting a timing control unit and a programmable gamma correction buffer circuit unit, wherein an uneven brightness distribution compensation module is embedded in the timing control unit, and a gamma correction module and a common electrode voltage setting module are embedded in the programmable gamma correction buffer circuit unit;
providing a serial peripheral interface, the serial peripheral interface electrically coupled to the timing control unit and the storage unit; and
providing an integrated circuit bus, the integrated circuit bus electrically coupled to the timing control unit and the programmable gamma correction buffer circuit unit.

13. The driving method of a display device according to claim 12, wherein the common electrode voltage setting code is electrically coupled to the gamma correction code and the uneven brightness distribution compensation module code.

14. The driving method of a display device according to claim 12, wherein the timing control unit is used for controlling a display sequence of a pixel and transmitting a signal to a driving unit of the display module.

15. The driving method of a display device according to claim 12, wherein the programmable gamma correction buffer circuit unit dynamically monitoring and adjusting a voltage by a software.

16. The driving method of a display device according to claim 12, wherein the programmable gamma correction buffer circuit unit further comprises a gamma correction module.

17. The driving method of a display device according to claim 16, wherein the programmable gamma correction buffer circuit unit further comprises a common electrode voltage setting module, and the gamma correction module is electrically coupled to the common electrode voltage setting module.

18. The driving method of a display device according to claim 12, wherein the step of providing the serial peripheral interface and electrically coupled to the serial peripheral interface to the timing control unit and the storage unit, comprises:
when the power is on, the timing control unit passing through a serial peripheral interface;
reading the uneven brightness distribution compensation module code in the storage unit according to storage addresses; and
transmitting to the uneven brightness distribution compensation module for data matching.

19. The driving method of a display device according to claim 12, wherein the step of providing an integrated circuit bus, the integrated circuit bus electrically coupled to the timing control unit and the programmable gamma correction buffer circuit unit, comprises:
reading the gamma correction code and the common electrode voltage setting code in the storage unit;
passing through the integrated circuit bus; and
transmitting to the gamma correction module and the common electrode voltage setting module in the programmable gamma correction buffer circuit unit for data matching.

20. A driving apparatus of a display device, comprising:
a first substrate including:
a storage unit electrically connected to a display module, for saving display parameters of the display module;
a second substrate including:
a control module electrically coupled to the storage unit, for reading the display parameters saved in the storage unit and adjusting driving parameters for the display module;
a timing control unit for controlling a display sequence of a pixel and transmitting a signal to a driving unit of the display module;
a programmable gamma correction buffer circuit unit dynamically monitoring and adjusting a voltage by a software;
a serial peripheral interface electrically coupled to the timing control unit and the storage unit;
an integrated circuit bus electrically coupled to the timing control unit and the programmable gamma correction buffer circuit unit; and
a power control unit for providing a power to the timing control unit;
wherein the storage unit further comprises a gamma correction code, a common electrode voltage setting code and an uneven brightness distribution compensation module code; the common electrode voltage setting code is electrically coupled to the gamma correction code and the compensation uneven brightness distribution module code; the timing control unit further comprises an uneven brightness distribution compensation module; the programmable gamma correction buffer circuit unit further comprises a gamma correction module and a common electrode voltage setting module; and the gamma correction module is electrically coupled to the common electrode voltage setting module.
